(19) United States
(12) Patent Application Publication
(10) Pub. No.: US 2022/0290971 A1
(43) Pub. Date: Sep. 15, 2022

(54) COORDINATE MEASURING APPARATUS

(71) Applicant: MITUTOYO CORPORATION, Kanagawa (JP)

(72) Inventors: Tsutomu ICHIMURA, Tokyo (JP); Kazuhiko HIDAKA, Tokyo (JP); Masaoki YAMAGATA, Kanagawa (JP)

(73) Assignee: MITUTOYO CORPORATION, Kanagawa (JP)

(21) Appl. No.: 17/687,271

(22) Filed: Mar. 4, 2022

(30) Foreign Application Priority Data
Mar. 9, 2021 (JP) 2021-037325

(51) Int. Cl. G01B 11/00; G01S 17/42

(52) U.S. Cl. CPC G01B 11/002; G01S 17/42

(57) ABSTRACT

A coordinate measuring apparatus includes a measuring part that measures a workpiece, three or more access points that are provided at positions away from the measuring part and perform wireless communication with the measuring part using radio waves, a laser tracker that irradiates a reflection part provided in each access point with a laser beam and receives the laser beam reflected by the reflection part, and a control part that obtains a first coordinate of the each access point by the laser tracker receiving the laser beam reflected by the reflection part, obtains a second coordinate of the measuring part on the basis of the wireless communication between the access point and the measuring part, causes the measuring part to measure a third coordinate of the workpiece, and obtains a spatial coordinate of the workpiece on the basis of the first coordinate, the second coordinate, and the third coordinate.

### CROSS-REFERENCE TO RELATED APPLICATIONS

The present application claims priority to Japanese Patent Applications number 2021-037325, filed on Mar. 9, 2021. The contents of this applications are incorporated herein by reference in their entirety.

### BACKGROUND OF THE INVENTION

The present disclosure relates to a coordinate measuring apparatus for determining spatial coordinates of a workpiece.

A laser tracker is used to determine three-dimensional coordinates of a workpiece. A laser tracker disclosed in PTL 1 below determines three-dimensional coordinates of a target (for example, a reflector on a workpiece) by irradiating the target with a laser beam and receiving the laser beam reflected by the target.

Incidentally, there is a case where a barrier such as a wall exists between a laser tracker and a target in a space where the workpiece is installed. In this case, since the laser beam does not pass through the barrier, the laser tracker cannot receive the radiated laser beam and cannot properly determine the three-dimensional coordinates of the target.

### BRIEF SUMMARY OF THE INVENTION

The present disclosure focuses on these points, and an object of the present disclosure is to properly determine spatial coordinates of a workpiece by using a laser tracker.

A first aspect of the present disclosure provides a coordinate measuring apparatus including a measuring part that measures a workpiece, three or more access points that are provided at positions away from the measuring part and perform wireless communication with the measuring part using radio waves, a laser tracker that irradiates a reflection part provided to each access point with a laser beam and receives the laser beam reflected by the reflection part, and a control part that determines a first coordinate of the each access point by the laser tracker receiving the laser beam reflected by the reflection part, determines a second coordinate of the measuring part on the basis of the wireless communication between the access point and the measuring part, causes the measuring part to measure a third coordinate of the workpiece, and determines spatial coordinates of the workpiece on the basis of the first coordinate, the second coordinate, and the third coordinate.

### BRIEF DESCRIPTION OF THE DRAWINGS

FIG. 1 is a schematic diagram illustrating a configuration of a coordinate measuring apparatus 1 according to an embodiment.

FIG. 2 is a schematic diagram illustrating positions of a measuring part 10, an access point 20, and a laser tracker 30 in a measuring chamber 90.

FIG. 3 is a schematic diagram illustrating communication between a plurality of access points 20a to 20f and the measuring part 10.

FIG. 4 is a schematic diagram illustrating an example of a configuration of the laser tracker 30.

FIG. 5 is a schematic diagram illustrating a relationship between the laser tracker 30 and the plurality of access points 20a to 20f.

FIG. 6 is a schematic diagram illustrating candidate points of a second coordinate.

### DETAILED DESCRIPTION OF THE INVENTION

### <Configuration of Coordinate Measuring Apparatus>

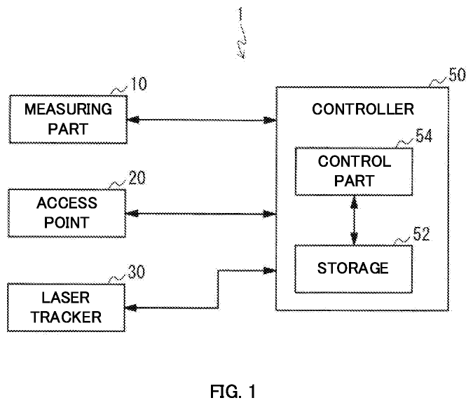

A configuration of a coordinate measuring apparatus according to an embodiment will be described with reference to FIGS. 1 to 6.

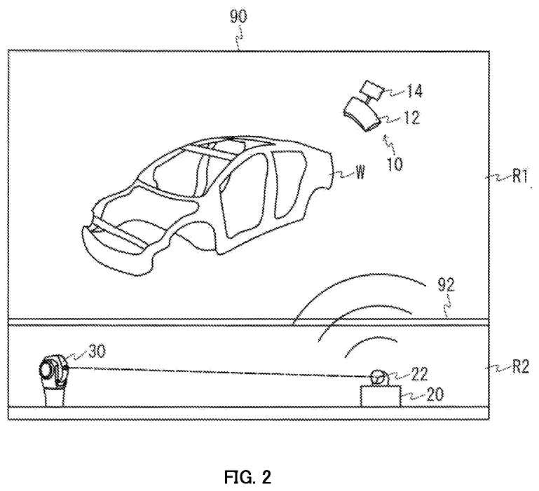

FIG. 1 is a schematic diagram illustrating a configuration of a coordinate measuring apparatus 1 according to an embodiment. FIG. 2 is a schematic diagram illustrating positions of a measuring part 10, an access point 20, and a laser tracker 30 in a measuring chamber 90. It should be noted that although there are actually a plurality of access points 20, only one access point 20 is shown in FIG. 2 for convenience of explanation.

The coordinate measuring apparatus 1 measures spatial coordinates of a workpiece W provided in a measuring space of the measuring chamber 90. As shown in FIG. 1, the coordinate measuring apparatus 1 includes the measuring part 10, the access point 20, the laser tracker 30, and a controller 50.

The measuring chamber 90 is a room in a building, for example. As shown in FIG. 2, the measuring chamber 90 includes a first space R1 and a second space R2. Here, the first space R1 is a space above a floor 92 of the measuring chamber 90 (space above the floor), and the second space R2 is a space under the floor 92 (space under the floor).

The floor 92 of the measuring chamber 90 is a wall separating the first space R1 and the second space R2. The floor 92 is made of a material that blocks laser beams of the laser tracker 30 while not blocking radio waves of wireless communication. This allows for wireless communication between the measuring part 10 in the first space R1 and the access point 20 in the second space R2. The floor 92 may be made of concrete or wood, for example.

As shown in FIG. 2, the workpiece W is located in the first space R1 in the measuring chamber 90. The workpiece W is a skeleton of a vehicle here, but is not limited thereto. Further, the workpiece W may be fixed in the first space R1, or may be moved in the first space R1 during measurement.

The measuring part 10 is provided in the first space R1, and measures the workpiece W. The measuring part 10 can be moved relative to the workpiece W, and measures the entire workpiece W while moving. The measuring part 10 may be provided on an arm of a movable robot. As shown in FIG. 2, the measuring part 10 includes a measuring sensor 12 and a communication part 14.

The measuring sensor 12 is a non-contact type of sensor, and measures the workpiece W while separated from the workpiece W. However, the measuring sensor 12 is not limited to the above, and may be a contact-type sensor that measures the workpiece W while following a shape of the workpiece W, for example.

Here, the communication part 14 performs wireless communication with the access point 20 using radio waves. That is, the communication part 14 located in the first space R1 performs the wireless communication with the access point 20 located in the second space R2.

Although not shown in FIGS. 1 and 2, the measuring part 10 may include a movement mechanism for moving the measuring sensor 12. The measuring sensor 12 can be moved in the three-axis directions in the first space R1, for example, by a moving mechanism.

As shown in FIG. 2, the access point 20 is provided in the second space R2, which is the space under the floor, and performs the wireless communication with the measuring part 10 located in the first space R1 using radio waves. The access point 20 is provided with a reflection part 22 that reflects the laser beam radiated by the laser tracker 30. The reflection part 22 is provided above the access point 20 here, but is not limited thereto. The access point 20 includes a communication part that performs wireless communication with the measuring part 10.

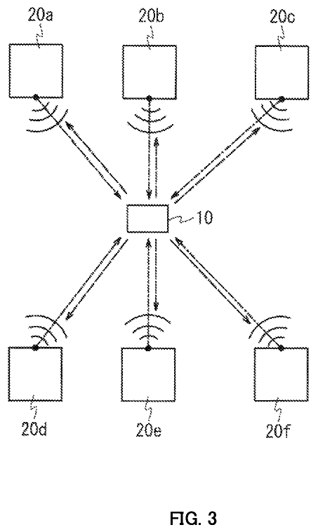

There are actually a plurality of access points 20, but only one access point 20 is shown in FIG. 1 for convenience of explanation. There are three or more access points 20 provided (see FIG. 3), but it is preferable to provide four or more access points 20. The plurality of access points 20 are spaced apart from each other in the second space R2. Each of the plurality of access points 20 performs wireless communication with the measuring part 10 located in the first space R1 using radio waves. Coordinates of the measuring part 10 can be determined by communicating between the access point 20 and the measuring part 10.

FIG. 3 is a schematic diagram illustrating the communication between a plurality of access points 20a to 20f and the measuring part 10. FIG. 3 shows a positional relationship when viewed from above the measuring part 10, and the floor 92 is omitted for the sake of illustration. Here, it is assumed that there are six access points 20a to 20f, and the access points 20a to 20f are arranged so as to surround the measuring part 10. The measuring part 10 first transmits a predetermined communication signal to one access point (for example, the access point 20a) as the communication between the access points 20 and the measuring part 10. Next, when one access point 20a receives the communication signal, said access point 20a transmits a response signal to the measuring part 10. The distance between the measuring part 10 and the access point 20a can be determined from the time from when the measuring part 10 sends the predetermined communication signal to the access point 20a to when the response signal is received from the access point 20a. The distances between the measuring part 10 and the other access points 20b to 20f can be determined by the measuring part 10 communicating in the same manner with the access points 20b to 20f.

It should be noted that, although not shown in FIG. 3, even if a pillar, a wall, or the like is placed in the space R1, the access points 20a to 20f can communicate wirelessly with the measuring part 10 because the radio waves are not blocked by the pillar or wall.

As shown in FIG. 2, the laser tracker 30 is provided in the second space R2. That is, the laser tracker 30 is located in a different space from the measuring part 10 and in the same space as the access point 20. The laser tracker 30 measures the reflection part 22 provided to the access point 20. The laser tracker 30 irradiates the reflection part 22 with the laser beam, and receives the laser beam reflected by the reflection part 22. The distance between the laser tracker 30 and the reflection part 22 of the access point 20 is determined by receiving the laser beam reflected by the reflection part 22.

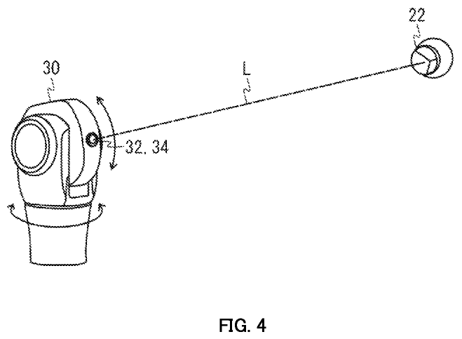

FIG. 4 is a schematic diagram illustrating an example of a configuration of the laser tracker 30. The laser tracker 30 includes a radiation part 32 and a light receiving part 34. The radiation part 32 irradiates the reflection part 22 of the access point 20 with a laser beam L. The light receiving part 34 receives the laser beam L reflected by the reflection part 22. The radiation part 32 and the light receiving part 34 are provided at the same position here. Further, the laser tracker 30 includes a driving part that rotates the radiation part 32 and the light receiving part 34 in the directions of two arrows shown in FIG. 4. This adjusts the angle of the radiation part 32 such that the laser beam is radiated to the reflection part 22 of the access point 20.

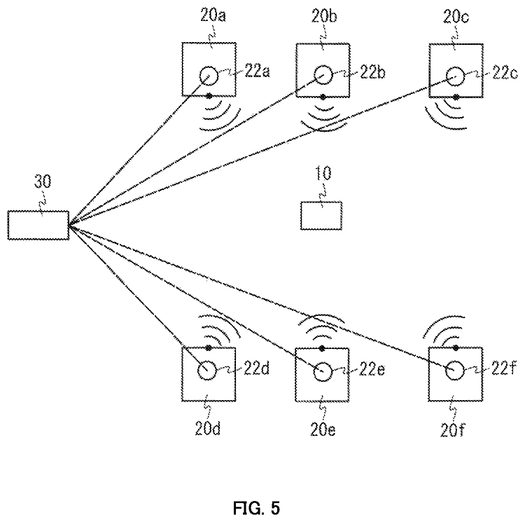

As described above, the plurality of access points 20 are provided in the second space R2, and the laser tracker 30 radiates the laser beam to the reflection parts 22 (reflection parts 22a to 22f shown in FIG. 5) of the plurality of access points 20. Thus, the distances between the laser tracker 30 and the reflection parts 22 of the plurality of access points 20 are determined.

FIG. 5 is a schematic diagram illustrating a relationship between the laser tracker 30 and the plurality of access points 20a to 20f. The laser tracker 30 sequentially irradiates the reflection parts 22a to 22f of the access points 20a to 20f with the laser beams, and sequentially receives the laser beams from the reflection parts 22a to 22f. At this time, the laser tracker 30 radiates the laser beam while adjusting the angle such that the radiation part 32 faces each of the reflection parts 22a to 22f. It should be noted that, in the second space R2, the laser tracker 30 and the access points 20a to 20f are arranged such that there is no barrier such as a wall between the laser tracker 30 and the access points 20a to 20f. Thus, the laser tracker 30 can measure the reflection parts 22a to 22f of the access points 20a to 20f.

The controller 50 controls operations of the measuring part 10, the access point 20, and the laser tracker 30 to determine the spatial coordinates of the workpiece W in the first space R1. As shown in FIG. 1, the controller 50 includes a storage 52 and a control part 54.

The storage 52 includes a Read Only Memory (ROM) and a Random Access Memory (RAM), for example. The storage 52 stores a program to be executed by the control part 54 and various data.

The control part 54 is, for example, a Central Processing Unit (CPU). The control part 54 executes the program stored in the storage 52 to perform the following process for determining the spatial coordinates of the workpiece W.

The control part 54 determines a first coordinate of the access point 20 (specifically, the reflection part 22) by causing the laser tracker 30 to irradiate the reflection part 22 of the access point 20 with the laser beam. Specifically, the control part 54 determines the first coordinate of the reflection parts 22a to 22f by irradiating the reflection parts 22a to 22f of the plurality of access points 20a to 20f provided in the second space R2 with the laser beams and receiving the laser beams reflected by the reflection parts 22a to 22f.

The control part 54 determines the second coordinate of the measuring part 10 on the basis of the wireless communication between the access point 20 and the measuring part 10. Specifically, first, the control part 54 determines the distance between the measuring part 10 and the access point 20 from the time required for the measuring part 10 to transmit and receive communication between the access point 20. In this case, the control part 54 determines the distance by integrating (a) half of the time required for transmitting and receiving the communication and (b) the light velocity. Then, the control part 54 determines the second coordinate of the measuring part 10 from the determined distance and the coordinates of the access point 20 (that is, the first coordinate).

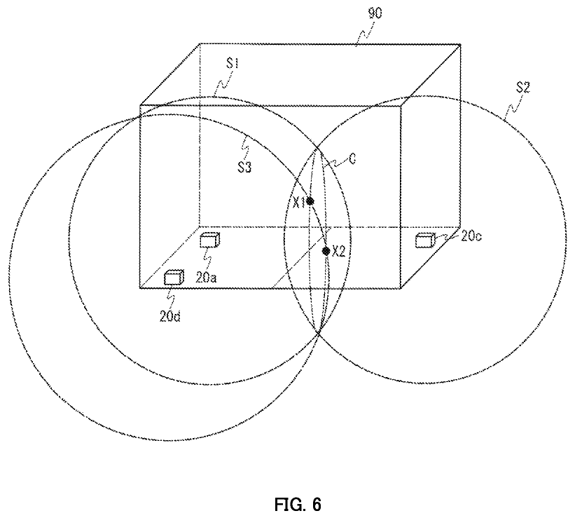

FIG. 6 is a schematic diagram illustrating candidate points of the second coordinate. Here, only three access points 20a, 20c, and 20d are shown for convenience of explanation. A spherical surface 51 represents a range of radio waves emitted from the access point 20a (spherical surface). A spherical surface S2 represents a range of radio waves emitted from the access point 20c (spherical surface). A spherical surface S3 represents a range of radio waves emitted from the access point 20d (spherical surface). A circle C represents a portion where the radio waves of the access point 20a and the radio waves of the access point 20c overlap. Candidate points X1 and X2 are points where the circle C and the spherical surface S3 intersect. Here, the candidate point X1 is located in the first space R1, and the candidate point X2 is located in neither the first space R1 nor the second space R2. Therefore, the candidate point X2 is removed from a list of candidates, and the candidate point X1 becomes the final candidate for the second coordinate of the measuring part 10.

Therefore, the coordinates of the measuring part 10 can be identified by determining the distances between the three access points and the measuring part 10. However, the present disclosure is not limited to the above, and the control part 54 may determine the distances between four access points 20 and the measuring part 10, and determine the second coordinate from the determined distances and the first coordinate. There is only one candidate point in this case, and so the second coordinate of the measuring part 10 can be easily determined.

When the measuring part 10 moves relative to the workpiece W as described above, the control part 54 determines the second coordinate of the measuring part 10 from the communication between the measuring part 10 and the access point 20 after the movement. Thus, the coordinates of the measuring part 10 while measuring the workpiece W can be determined.

The control part 54 operates the measuring part 10 to measure the coordinates of the workpiece W (third coordinate). That is, the control part 54 determines the third coordinate of the workpiece W by causing the measuring part 10 to measure the workpiece W while moving relative to the workpiece W.

The control part 54 determines the spatial coordinates of the workpiece W in the first space R1 on the basis of the determined first coordinate, second coordinate, and third coordinate. That is, the control part 54 determines the spatial coordinates of the workpiece W measured by the measuring part 10 in the first space R1 using the laser tracker 30 and the access point 20.

In the above explanation, the first space R1 is the space above the floor 92 of the measuring chamber 90, and the second space R2 is the space under the floor 92, but they are not limited thereto. For example, the second space R2 may be a space above a ceiling of the measuring chamber 90, and the first space R1 may be a space under the ceiling.

Further, in the above description, the laser tracker 30 and the access point 20 are provided in a space different from the space where the measuring part 10 is provided, but they are not limited thereto. For example, the laser tracker 30 and the access point 20 may be provided at positions separated from each other in the same space as the measuring part 10 (that is, the space R1).

As an example, the plurality of access points 20 may be fixed to the ceiling or wall of the first space R1, and the laser tracker 30 may be disposed on the floor of the first space R1. In this case, before the workpiece W is brought into the first space R1, the laser tracker 30 measures the reflection parts 22 of the access points 20 to determine the first coordinate. Thereafter, the space coordinates of the workpiece W can be determined by determining the second coordinate and the third coordinate after the workpiece W is brought into the first space R1.

It should be noted that the laser tracker 30 may be fixed to the ceiling or the wall of the first space R1 in the same manner as the access point 20. In this case, the laser tracker 30 can measure the reflection parts 22 of the access points 20 even after the workpiece W is brought in. Thus, the spatial coordinates of the workpiece W can be determined by determining the first coordinate, the second coordinate, and the third coordinate after the workpiece W is brought in.

### <Effect of Present Embodiment>

The coordinate measuring apparatus 1 of the above-mentioned embodiment determines the first coordinate of each access point 20 by having the laser tracker 30 receive the laser beam reflected by the reflection parts 22 of the plurality of access points 20. Further, the coordinate measuring apparatus 1 determines the second coordinate of the measuring part 10 on the basis of the wireless communication between the measuring part 10 and the plurality of access points 20 provided at positions away from the measuring part 10. Furthermore, the coordinate measuring apparatus 1 determines the third coordinate of the workpiece measured by the measuring part 10. Then, the coordinate measuring apparatus 1 determines the spatial coordinates of the workpiece W on the basis of the determined first coordinate, second coordinate, and third coordinate.

Thus, even if there is a barrier (for example, a pillar or a wall) that blocks the laser beam of the laser tracker 30 in the space where the workpiece W is placed, the spatial coordinates of the workpiece W can be properly determined by placing the access point 20 that performs wireless communication using radio waves that are not blocked by said barrier.

The present invention is explained on the basis of the exemplary embodiments. The technical scope of the present invention is not limited to the scope explained in the above embodiments and it is possible to make various changes and modifications within the scope of the invention. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

What is claimed is:

1. A coordinate measuring apparatus comprising:
a measuring part that measures a workpiece;
three or more access points that are provided at positions away from the measuring part and perform wireless communication with the measuring part using radio waves;
a laser tracker that irradiates a reflection part provided to each access point with a laser beam and receives the laser beam reflected by the reflection part; and
a control part that determines a first coordinate of the each access point by the laser tracker receiving the laser beam reflected by the reflection part, determines a second coordinate of the measuring part on the basis of the wireless communication between the access point and the measuring part, causes the measuring part to measure a third coordinate of the workpiece, and determines spatial coordinates of the workpiece on the basis of the first coordinate, the second coordinate, and the third coordinate.

2. The coordinate measuring apparatus according to claim 1, wherein
the three or more access points are spaced apart from each other in a second space separated by a wall from a first space where the workpiece and the measuring part are provided,
the laser tracker is provided in the second space, and
the control part determines the spatial coordinates of the workpiece in the first space.

3. The coordinate measuring apparatus according to claim 2, wherein
the measuring part is provided in a space, as the first space, on a floor of the measuring chamber, and
the access points and the laser tracker are provided in a space, as the second space, under the floor of the measuring chamber.

4. The coordinate measuring apparatus according to claim 2, wherein
the wall is made of a material that blocks the laser beam and does not block the radio waves of the wireless communication.

5. The coordinate measuring apparatus according to claim 2, wherein
the access points are arranged so as to surround the measuring part when the first space and the second space are viewed from above.

6. The coordinate measuring apparatus according to claim 1, wherein
the measuring part moves relative to the workpiece, and
the control part determines the second coordinate of the measuring part from the communication between the measuring part and the access points after the movement.

7. The coordinate measuring apparatus according to claim 1, wherein
the measuring part includes a communication part that sequentially performs the wireless communication with the access points.

8. The coordinate measuring apparatus according to claim 1, wherein
the control unit determines a distance between the access points and the measuring part from a time required for transmitting and receiving communication between the access points and the measuring part, and determines the second coordinate from the determined distance and the first coordinate.

9. The coordinate measuring apparatus according to claim 8, wherein
the control part determines distances between four access points and the measuring part, and determines the second coordinate from the determined distances and the first coordinate.

10. The coordinate measuring apparatus according to claim 1, wherein
the control part determines, as the second coordinate, an intersection point of four spherical surfaces respectively indicating a range of radio waves emitted from the four access points whose first coordinate have been determined.
